(19) United States
(12) Patent Application Publication
(10) Pub. No.: US 2003/0174194 A1
(43) Pub. Date: Sep. 18, 2003

(54) Image forming apparatus

(76) Inventors: Hiromitsu Tsutsui, Nara-shi (JP); Ryoichi Kawai, Kitakatsuragi-gun (JP)

Correspondence Address: BIRCH STEWART KOLASCH & BIRCH, PO BOX 747, FALLS CHURCH, VA, 22040-0747, US

(21) Appl. No.: 10/368,418

(22) Filed: Feb. 20, 2003

(30) Foreign Application Priority Data
Feb. 20, 2002 (JP) P2002-43858

(51) Int. Cl. B41J 2/01

(52) U.S. Cl. 347/104

(57) ABSTRACT

An object of the invention is to provide an image forming apparatus wherein quality of an image can be improved at the time of recording the image on a recording medium and its configuration can be simplified. The image forming apparatus comprises an ink cartridge capable of print on a recording sheet, an upstream side conveying mechanism, a downstream side conveying mechanism and a paper pressure flexible sheet for guiding the recording sheet under a predetermined pressure-contact condition when the tail end of the recording sheet passes through the upstream side conveying mechanism. Thereby, The conventional problem of a change of conveying amount of the recording sheet caused by a change of conveying speed of the recording sheet can be previously solved, and a relative distance of the recording sheet to the ink cartridge can be always stabilized.

### BACKGROUND OF THE INVENTION

1. Field of the Invention

The present invention relates to an image forming apparatus, for instance, to technique preferably used for a sheet feed mechanism of an ink jet printer or the like.

2. Description of the Related Art

Such an ink jet printer as an image forming apparatus is made available that an image is recorded on a recording sheet by spitting out a droplet of ink on a desired print position of a recording objective along with moving an ink cartridge in a main scanning direction through a carriage with respect to the recording sheet and conveying the recording sheet in a sub-scanning direction, according to a print command indicated by, e.g., a personal computer. FIG. 9 is a schematic view for explaining a conventional ink jet printer 1. FIGS. 10A to 10C are enlarged views of a main part showing a relation between an upstream side conveying mechanism 2 and a recording sheet 3. FIG. 11 is a view for explaining a condition of a position near a tail end of the recording sheet 3 just after the recording sheet 3 is apart from the upstream side conveying mechanism 2. FIG. 12 is a view for explaining a relative position of each portion with respect to a platen roller 4 in the conventional ink jet printer 1.

In the case where print is performed on the recording sheet 3 as a print objective, when after a plurality of sheets of recording sheet 3 is set on a recording sheet tray 5, for instance, a print command is indicated by a personal computer, print data is transferred to the ink jet printer 1. Next, a preset maintenance operation is performed for an ink cartridge 6 and then the ink cartridge 6 is moved from a home position to a print start position of the ink cartridge 6. Next, one sheet of recording sheet 3 is separated and taken out from the recording sheet tray 5 by a recording sheet separating portion 7. One recording sheet 3 is conveyed by a sheet feeding roller 8 to a position where a recording sheet detection sensor 9 is turned on and the recording sheet 3 is detected by turning the recording sheet detection sensor 9 on.

Subsequently, the recording sheet 3 is conveyed at a certain distance until the recording sheet 3 abuts on a platen roller 4 and then the recording sheet 3 is stopped. Next, a driving route of the sheet feed roller 8 is changed to that of the platen roller 4 by a driving system (not shown). The recording sheet 3 is conveyed to a position between the platen roller 4 and a recording sheet pressure roller 10 which is in pressure-contact with the platen roller 4. Subsequently, the recording sheet 3 is stopped once in a state where a leading end end of the recording sheet 3 is conveyed to the print start point by rotational driving of the platen roller 4. The ink cartridge 6 performs print by spitting out an ink on the basis of the print data along with moving the ink cartridge 6 from the print start position in a main scanning direction perpendicular to a conveying direction of the recording sheet 3 by a carriage (not shown). When print for one line is terminated, the ink cartridge 6 is returned to a predetermined standby position. Next, the recording sheet 3 is accurately fed by an amount corresponding to one line in the conveying direction as a sub-scanning direction by rotation driving of the platen roller 4 and print for the second line is performed in the state where the recording sheet 3 is stopped in the same way as mentioned above.

A discharge roller 11 and a discharge pinch roller 12 (also called “star roller”) are arranged on a downstream side of an ink spitting position of the ink cartridge 6 along a conveying path and these rollers 11 and 12 are rotated in synchronization with the rotation of the platen roller 4. A pressure-contact force generated between the discharge roller 11 and the discharge pinch roller 12 is set so as to become smaller than that generated between the platen roller 4 and the recording sheet pressure roller 10. The recording sheet 3 is conveyed by one line by the platen roller 4, and the recording sheet 3 is conveyed in the sub-scanning direction along with performing print on the basis of print data. Subsequently, when the leading end of the recording sheet 3 reaches the discharge roller 11, the recording sheet 3 is conveyed by one line in the sub-scanning direction by the platen roller 4 and the discharge roller 11, and print is performed by spitting out the ink from the ink cartridge 6 on the basis of print data.

When a tail end of the recording sheet 3 passes through the recording sheet detection sensor 9, the recording sheet detection sensor 9 is turned off, and after the recording sheet detection sensor 9 is turned off, print is also performed for the recording sheet 3 on the basis of print data. Subsequently, when more print is performed on the basis of print data, the tail end of the recording sheet 3 is apart from the platen roller 4, and thereafter print is performed to the tail end of the recording sheet 3 along with conveying the recording sheet 3 by only the discharge roller 11, and then print is terminated. Subsequently, the recording sheet 3 is discharged onto a recording sheet tray 13 by the discharge roller 11.

According to such a conventional technique, there is a problem that a subtle change of conveying speed occurs at the moment that the tail end 3a of the recording sheet 3 is apart from the platen roller 4, which leads to a change of a conveying amount of the recording sheet 3. FIG. 13 is a schematic plan view of print dots made by the conventional ink jet printer 1. In FIG. 13, a black circle and a white circle represent dots of ink spat out. As shown in FIG. 13, since a print position is deviated from a normal print position due to the change of the amount of conveying the recording sheet 3, cross lines in the main scanning direction of the recording sheet 3 or color unevenness in the case of polychromic print occurs. In other words, in the normal print condition, an ink is spat out from a nozzle of the ink cartridge 6 and a black circle and a white circle are printed alternately. (see FIG. 8) Correspondingly, in the conventional technique, a phenomenon that the black circle and the white circle are not printed alternately due to the change of the amount of conveying the recording sheet 3 occurs, and the black circle and the white circle are separated from each other or overlaps with each other. Therefore, cross lines in the main scanning direction of the recording sheet 3 or color unevenness in the case of polychromic print occurs.

In addition, just after the tail end 3a of the recording sheet 3 is apart from the platen roller 4, the tail end 3a rises a little upward and a distance CP between an ink jet orifice 6a and the tail end 3a of the recording sheet 3 is changed. Consequently, an impact point of ink varies and color unevenness in the case of polychromic print occurs. To eliminate these cross lines or uneven colors, there is such a method that a recording sheet having longer size in the sub-scanning direction than a predetermined size is previously prepared and such a countermeasure is taken that the tail end of the recording sheet is prevented from being apart from a platen roller in the middle of print and an unnecessary part of the tail end is cut off after print is terminated. However, the recording sheet having longer size than the predetermined size should be prepared, and besides, a work for cutting off an unnecessary part of the recording sheet should be required, so that working efficiency becomes low.

### SUMMARY OF THE INVENTION

Consequently, an object of the invention is to provide an image forming apparatus enabling quality of an image at the time of recording the image in a recording medium to be improved and also enabling its configuration to be simplified.

The invention provides an image forming apparatus comprising:

recording means for recording a desired image on a recording medium;

recording medium conveying means capable of conveying the recording medium, including upstream side conveying means and arranged on an upstream side of the recording means along a conveying path and downstream conveying means arranged on a downstream side of the recording means along the conveying path; and

guiding means for guiding the recording medium under a predetermined pressure-contact condition when a tail end of the recording medium passes through the upstream side conveying means or after the tail end of the recording medium passes through the upstream side conveying means.

According to the invention, when the desired image is recorded on the recording medium, the recording medium is conveyed to the upstream side conveying means arranged on the upstream side of the recording means and then the image is recorded on the recording medium in cooperation with an operation of the upstream side conveying means. In a state where the recording medium is conveyed to the downstream side conveying means on the downstream side of the recording means, the image is recorded on the recording medium similarly as mentioned above in cooperation with operations of the upstream side conveying means and the downstream side conveying means. And then, when the tail end of the recording medium passes through the upstream side conveying means or after the tail end of the recording medium passes through the upstream side conveying means, the guiding means guides the recording medium under the predetermined pressure-contact condition. Therefore, the problem of the change of the conveying amount of the recording medium due to the change of conveying speed of the recording medium as mentioned concerning the conventional technique can be previously solved, and besides, a relative distance of the recording medium to the recording means can be always stabilized.

According to the invention, when the tail end of the recording medium passes through the upstream side conveying means or after the tail end of the recording medium passes through the upstream side conveying means, the guiding means guides the recording medium under the predetermined pressure-contact condition. Therefore, the problem of the change of conveying amount of the recording medium due to the change of conveying speed of the recording medium as mentioned concerning the conventional technique can be previously solved, so that deviation of a recording position from the normal position can be prevented from occurring. For instance, cross lines in the main scanning direction of the recording medium or color unevenness in the case of polychromic printing can be certainly prevented from occurring. In addition, since a relative distance of the recording medium to the recording means can be always stabilized, variation of an impact point of a droplet can be suppressed and color unevenness can be prevented from occurring in the case of polychromic print.

In addition, in the invention it is preferred that the guiding means is provided in the upstream side conveying means.

According to the invention, when the image is recorded on the tail end of the recording medium, quality of the image can be improved and its configuration can be simplified.

In addition, according to the invention, since the guiding means is provided in the upstream side conveying means, the quality of the image can be improved at the time of recording the image on the tail end of the recording medium and its configuration can be simplified.

In addition, in the invention it is preferred that the upstream side conveying means comprises: a pair of rotating rollers capable of sandwiching the recording medium between the rollers and being rotatable; and a roller holder supporting one rotating roller which is elastically energized against another rotating roller, and that the guiding means is provided in the roller holder.

According to the invention, even in a state where the tail end of the recording medium is apart from one rotating roller which is elastically energized against another rotating roller, the guiding means provided in the roller holder can guide at least the tail end of the recording medium by means of elastic force under the predetermined pressure-contact condition.

In the invention it is preferable that the guiding means is formed of a sheet of synthetic resin.

In the invention it is preferable that the guiding means is formed of a metal.

In the invention it is preferable that the guiding means guides the tail end of the recording medium between the upstream side conveying means and the recording means under the predetermined pressure-contact condition.

### BRIEF DESCRIPTION OF THE DRAWINGS

Other and further objects, features, and advantages of the invention will be more explicit from the following detailed description taken with reference to the drawings wherein:

FIG. 1 is a schematic plan view of an image forming apparatus in accordance with one embodiment of the invention;

FIG. 2 is a block diagram of a control system;

FIG. 3 is a side view of a peripheral portion of an upstream side conveying mechanism;

FIG. 4 is an enlarged side view of a paper pressure flexible sheet;

FIG. 5 is an enlarged view of a main part showing a relation between the paper pressure flexible sheet and a platen roller;

FIG. 6 is an enlarged view of the paper pressure flexible sheet under the non-pressure contact condition;

FIG. 7 is a flow chart of a series of operation sequences;

FIG. 8 is a schematic plan view of print dot made by the image forming apparatus in accordance with one embodiment of the invention;

FIG. 9 is a schematic view for explaining a conventional ink jet printer;

FIGS. 10A to 10C are enlarged views of a main part showing a relation between an upstream side conveying mechanism and a recording sheet;

FIG. 11 is a view for explaining a condition of a position near a tail end of the recording sheet just after the recording sheet is apart from the upstream side conveying mechanism;

FIG. 12 is a view for explaining a relative position of each portion with respect to a platen roller in the conventional ink jet printer; and

FIG. 13 is a schematic plan view of print dot made by the conventional ink jet printer.

### DETAILED DESCRIPTION OF THE PREFERRED EMBODIMENTS

Now referring to the drawings, preferred embodiments of the invention are described below.

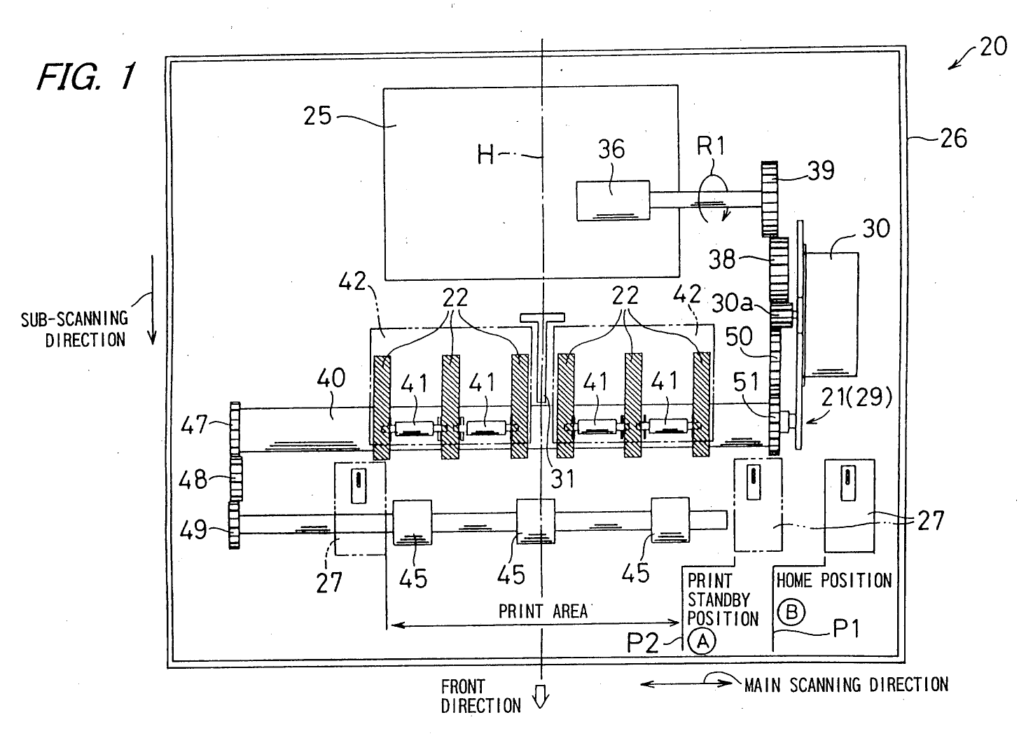

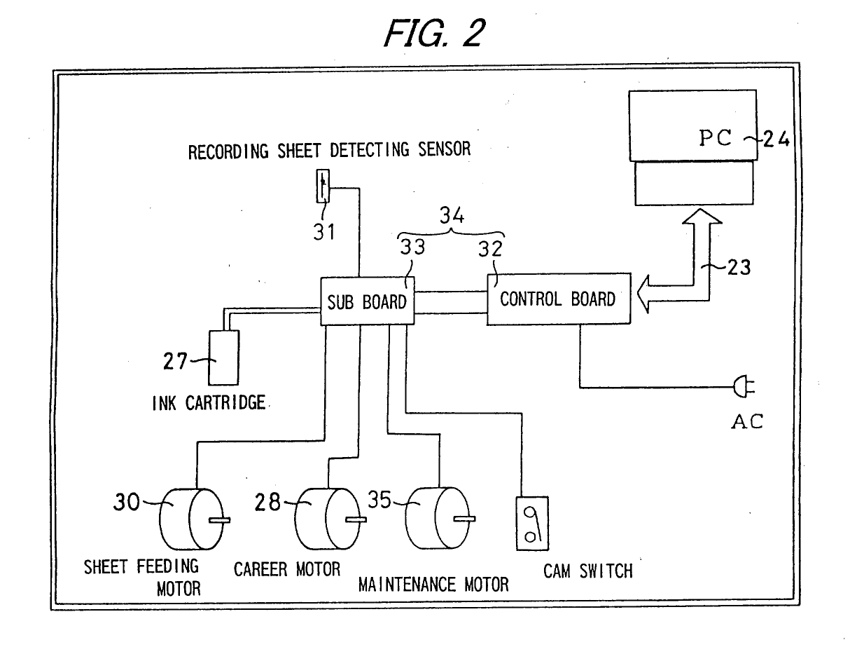

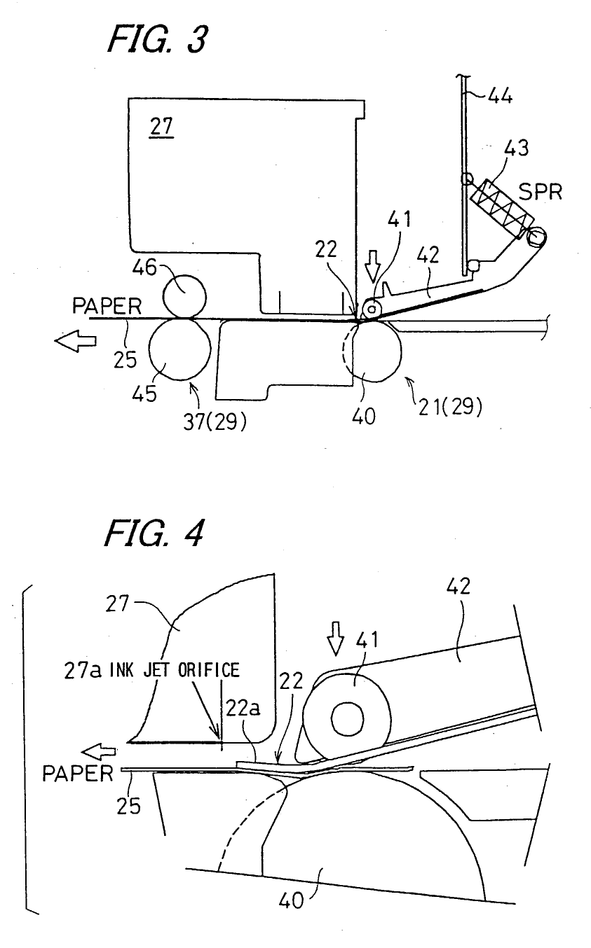

FIG. 1 is a schematic plan view of an image forming apparatus in accordance with one embodiment of the invention, and FIG. 2 is a block diagram of a control system, and FIG. 3 is a side view of a peripheral portion of an upstream side conveying mechanism 21. The present embodiment is an example of the case where an image forming apparatus is applied to an ink jet printer 20. The ink jet printer 20 is, for instance, connected to a personal computer 24 via a dedicated cable 23 and is configured so that print can be performed on a recording sheet 25 as a recording medium on the basis of a print command indicated by the personal computer 24. In addition, a printer driver for driving the ink jet printer 20 is installed in the personal computer 24. Hereinafter, a downstream side of a conveying path H for the recording sheet 25 in FIG. 1 is defined as a frond direction, and an upstream side of the conveying path H is defined as a rear direction, and left and right sides of the conveying path H are defined as left and right directions, respectively. The following explanation is given according to the definition.

The ink jet printer 20 mainly comprises a cover member 26, an ink cartridge 27, a carriage (not shown), a carriage driving source 28, a conveying mechanism 29, a driving motor 30 for the conveying mechanism, a paper pressure flexible sheet 22 as guiding means, a recording sheet detecting sensor 31, a control unit 34 including a control board 32 and a sub board 33, a maintenance unit (not shown) and a maintenance motor 35. A recording sheet tray on which a plurality of recording sheets 25 can be stacked is attached to a back portion of the cover member 26 so as to incline in the rear direction so that the distal end thereof is positioned upward. A recording sheet discharge tray on which the printed recording sheet 25 is discharged and held is attached to a lower end portion of a front section of the cover member 26 so as to project toward the front direction. In addition, a recording sheet separation portion for separating the plurality of recording sheets 25 stacked on the recording sheet tray is provided on a lower end portion of the recording sheet discharge tray.

Inside the cover member 26, an ink tank (not shown) is detachably held in the ink cartridge 27 and the ink cartridge 27 is configured so as to be detachable on an carriage and movable in right/left direction, i.e., a main scanning direction. The control unit 34 is configured so as to drive the carriage driving source 28 (a career motor 28) and spit out a droplet of ink on a desired print position of recording objective of the recording sheet 25 along with moving the ink cartridge 27 via the carriage in the main scanning direction on the basis of the print command. The ink cartridge 27, the carriage and the career motor 28 or the like correspond to recording means.

The conveying mechanism 29 as recording medium conveying means capable of conveying the recording sheet 25 includes sequentially a sheet feeding roller 36, the upstream side conveying mechanism 21 as upstream side conveying means and a downstream side conveying mechanism 37 as downstream side conveying means along the conveying path H, which are arranged in the cover member 26, respectively. The sheet feeding roller 36 having a rotating shaft center extending in the right/left direction is arranged just ahead of the recording sheet tray so as to be rotatably around the rotating shaft center, and the sheet feeding roller 36 is rotationally driven in a clockwise direction R1 viewing from the right direction by the driving motor 30 for conveying mechanism (also named as a sheet feeding motor 30) via gears 38 and 39. The sheet feeding roller 36 applies pressure contact at a constant pressure to the recording sheet 25 arranged in the front row among the plurality of recording sheets 25 stacked on the recording sheet tray. Under this condition, the recording sheet 25 is fed one by one to the upstream side conveying mechanism 21 by rotationally driving the sheet feeding roller 36 in the clockwise direction R1 by the driving motor 30.

The upstream side conveying mechanism 21 is arranged on the upstream side of the ink cartridge 27 along the conveying path H, and the upstream side conveying mechanism 21 including a platen roller 40, a plurality of recording sheet pressure rollers 41 as a pair of rotating rollers, a plurality of roller holders 42 for pressing a sheet of paper (hereinafter simply called “holder 42”) and a plurality of coil springs 43. In other words, the recording sheet pressure rollers 41 and the platen roller 40 are configured so that they have a rotating shaft center extending in the right/left direction, respectively, and they are arranged parallel to each other vertically, and they can vertically sandwich the recording sheet 25 conveyed in substantially horizontal direction, and they are rotatable around each rotating shaft center. After the driving route (a pinion 30a and gears 38 and 39) of the sheet feeding roller 36 is changed to a driving route (a pinion 30a and gears 50 and 51) of the platen roller 40 by a driving system (not shown), the platen roller 40 is rotationally driven counterclockwise in FIG. 3 via the gears 50 and 51 by the driving motor 30.

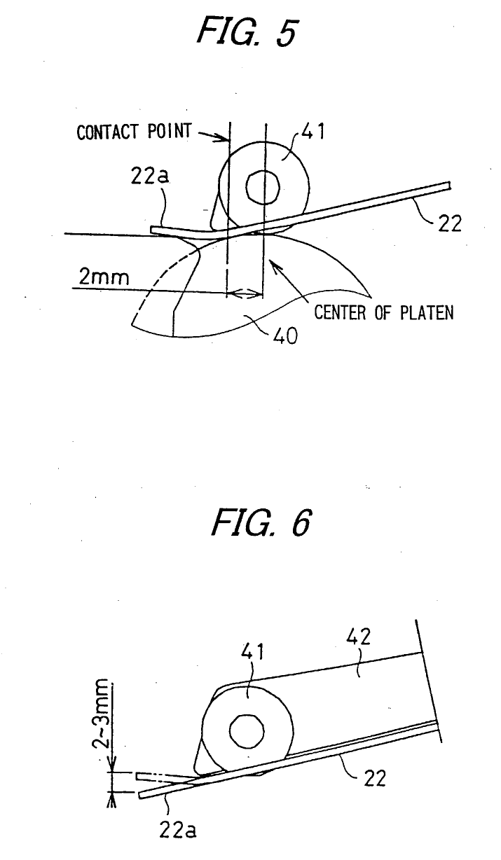

FIG. 4 is an enlarged side view of the paper pressure flexible sheet 22, and FIG. 5 is an enlarged view of a main part showing a relation between the paper pressure flexible sheet 22 and the platen roller 40, and FIG. 6 is an enlarged view of the paper pressure flexible sheet 22 under the non-pressure contact condition. A frame member 44 is arranged in a substantially vertical direction inside the cover member 26. On an lower portion of the frame member 44, a plurality of platy holders 42 are arranged at appropriate intervals in the right/left direction and are supported so as to swing up and down. The holders 42 have a function of holding the recording sheet pressure roller 41 and a function of guiding the recording sheet 25. In detail, each coil spring 43 is arranged between one end of each holder 42 and the frame member 44. The holder 42 is configured so that the recording sheet pressure roller 41 which is rotatably supported on another end of the holder 42 abuts on the platen roller 40 at a constant pressure-contact force by spring force of the coil spring 43, namely, spring force acting in a direction in which one end of the holder 42 comes close to the frame member 44.

Three rectangular paper pressure flexible sheets 22 are fixed toward a sub-scanning direction respectively in the bottom surface of each holder 42. These paper pressure flexible sheets 22 are arranged at constant intervals in the main scanning direction. Each paper pressure flexible sheet 22 is made of a material having appropriate elastic force, for instance, synthetic resin. A front end 22a of each paper pressure flexible sheet 22 is arranged so as to project from an ink jet orifice to a position which exists upstream by approximately 1 through 1.5 mm. When the platen roller 40 is rotationally driven counterclockwise as mentioned above in a state where the platen roller 40 abuts on the recorded sheet pressing roller 41, the recording sheet pressure roller 41 is driven clockwise and the recording sheet 25 held between the recording sheet pressure roller 41 and the platen roller 40 is fed toward the downstream side of the conveying path H to be provided for print.

When the tail end of the recording sheet 25 passes between the recording sheet pressure roller 41 and the platen roller 40, or after the tail end of the recording sheet 25 passes between the recording sheet pressure roller 41 and the platen roller 40, the paper pressure flexible sheet 22 has a function of guiding the recording sheet 25 under the predetermined pressure-contact condition by spring force of the coil spring 43 and elastic force of the paper pressure flexible sheet 22. As a concrete example, a part of each paper pressure flexible sheet 22 which exists on the rear side by, for instance, approximately 4.5 mm from the front end of each flexible sheet 22 is in pressure-contact with a position which exists downstream by approximately 2 mm in the conveying direction from the center, namely, the center of rotation of the platen roller 40 (See FIG. 5). In this case, the front end part 22a of the paper pressure flexible sheet 22 is attached so as to vertically bend by approximately 2 through 3 mm under the non-pressure contact condition, namely, free condition (See FIG. 6).

The downstream side conveying mechanism 37 is arranged on the downstream side of the recording means along the conveying path H, and the downstream side conveying mechanism 37 has a function of feeding the recording sheet 25 fed from the upstream side conveying mechanism 21 toward the downstream side and finally discharging the recording sheet onto the recording sheet discharge tray. The downstream side conveying mechanism 37 includes a discharge roller 45 and a discharge pinch roller 46. The discharge pinch roller 46 and the discharge roller 45 are configured so that they have a rotating shaft center extending in the right/left direction, respectively, and they are arranged parallel to each other vertically, and they can vertically sandwich the recording sheet 25 conveyed in substantially horizontal direction, and they is rotatable around each rotating shaft center. The discharge roller 45 is rotationally driven counterclockwise in FIG. 4 in synchronization with the platen roller 40 via gears 47, 48 and 49 by the driving motor 30 mentioned above. The discharge pinch roller 46 is configured so as to always abut on the discharge roller 45 with a constant pressure-contact force. Consequently, when the discharge roller 45 is rotationally driven counterclockwise, the discharge pinch roller 46 is driven clockwise and the recording sheet 25 sandwiched between the discharge pinch roller 46 and the discharge roller 45 is fed toward the downstream side of the conveying path H. In addition, the pressure-contact force generated between the discharge roller 45 and the discharge pinch roller 46 is set so as to become smaller than the pressure-contact force generated between the platen roller 40 and the recording sheet pressure roller 41 and so as to become larger than a pressure-contact force generated by elastic force of the paper pressure flexible sheet 22.

In particular, even after the tail end of the recording sheet 25 is apart from the platen roller 40 and the recording sheet pressure roller 41 under the pressure-contact condition of the recording sheet 25 toward the downstream side of the conveying path H, the tail end of the recording sheet 25 is guided under the predetermined pressure-contact condition by the elastic force of the paper pressure flexible sheet 22 and the spring force of the coil spring 43. Therefore, it is possible to prevent the tail end of the recording sheet 25 from rising generated just after the tail end of the recording sheet 25 is apart from the platen roller 40. Consequently, the distance between an ink jet orifice 27a and the recording sheet 25 is always kept constant and variation of an impact point of ink can be suppressed and color unevenness in the case of polychromic print can be prevented from occurring. Moreover, conveying force of the discharge roller 45 exceeds conveying force of the platen roller 40 generated by the paper pressure flexible sheet 22 because the pressure-contact force of each member is set as mentioned above. Therefore, a change of conveying speed of the recording sheet 25 can be suppressed as much as possible, and a change of conveying amount of the recording sheet 25 can be prevented, and deviation of a print position caused by the change of conveying amount of the recording sheet 25 can be prevented. Consequently, cross lines in the main scanning direction of the recording sheet 25 or color unevenness in the case of polychromic print can be certainly prevented from occurring.

In the frame member 44, the recording sheet detecting sensor 31 is provided in a substantial middle part of the main scanning direction of the recording sheet 25. The recording sheet 25 is conveyed by the sheet feeding roller 36 to a position where the recording sheet detecting sensor 31 is turned on, and detection of the recording sheet 25 is performed by turning the recording sheet detecting sensor 31 on. Subsequently, the recording sheet 25 is conveyed until the recording sheet 25 abuts on the platen roller 40 and then the recording sheet 25 is stopped. When most of printing on the recording sheet 25 is terminated and then the tail end of the recording sheet 25 passes through the recording sheet detecting sensor 31, the recording sheet detecting sensor 31 is turned off and then print is similarly performed on the recording sheet 25 on the basis of print data or the like.

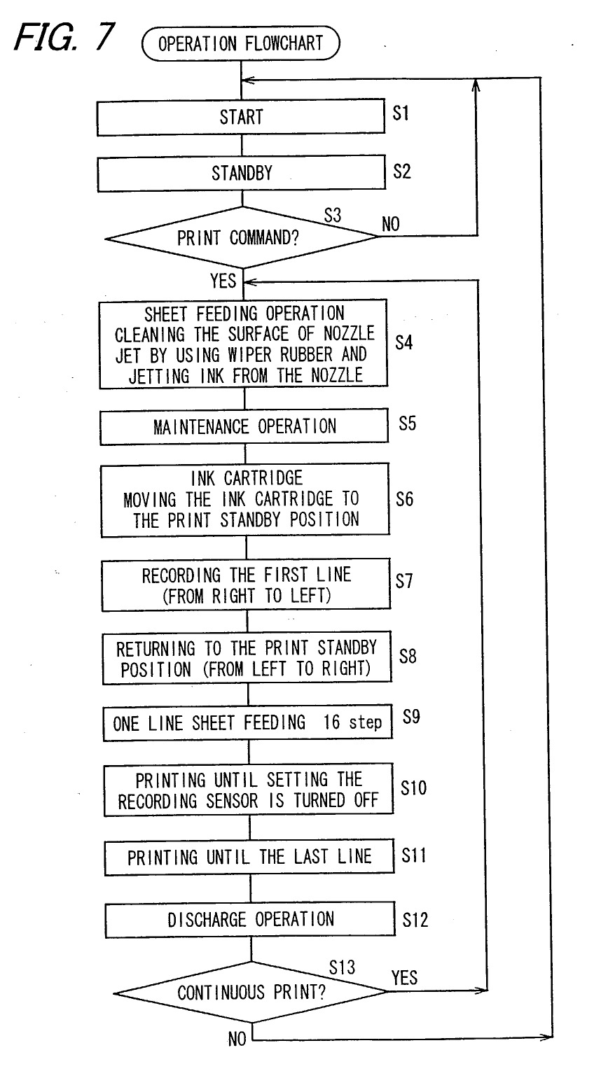

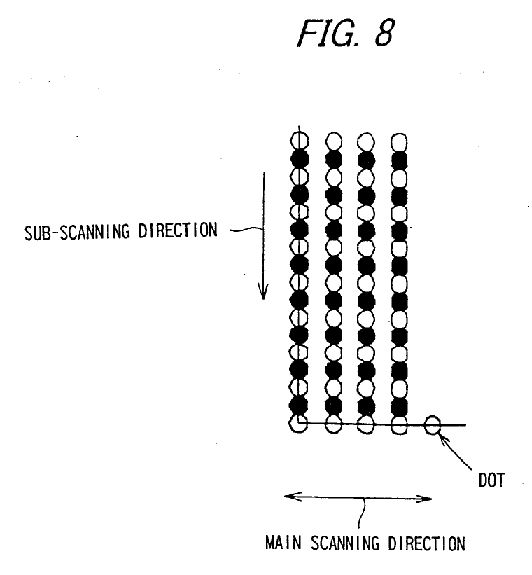

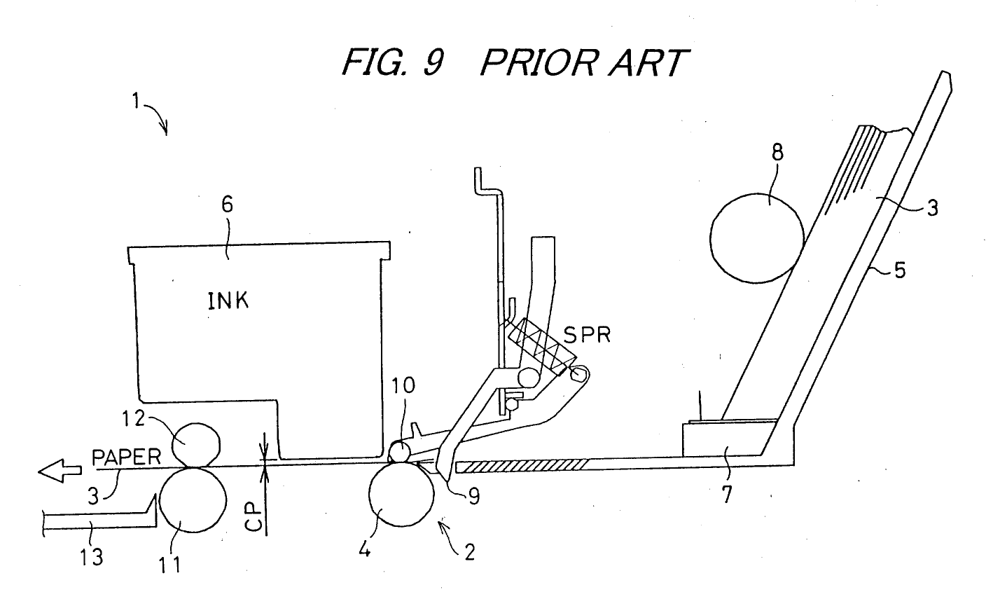

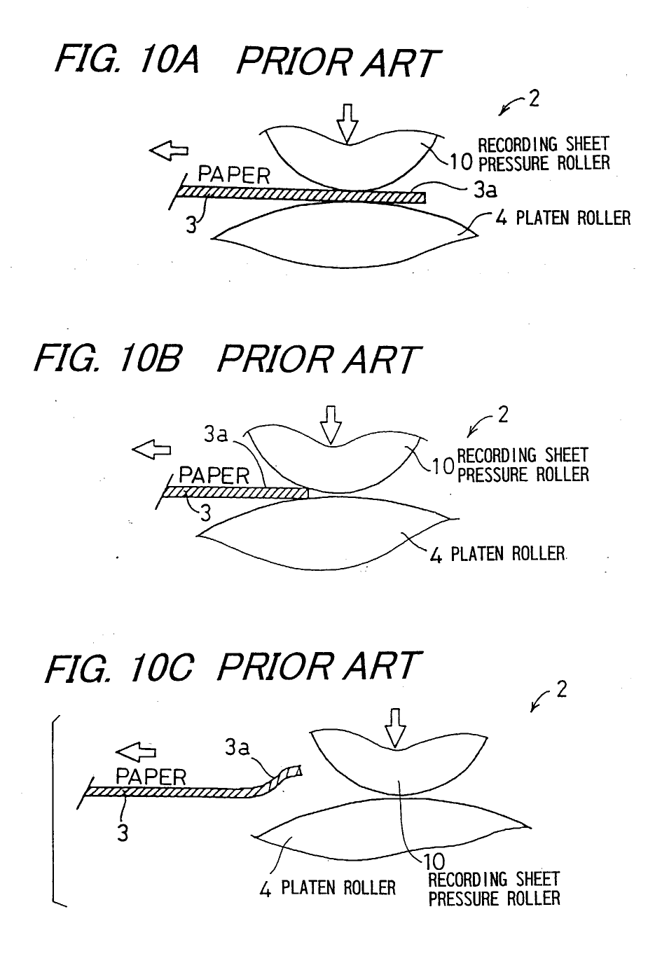

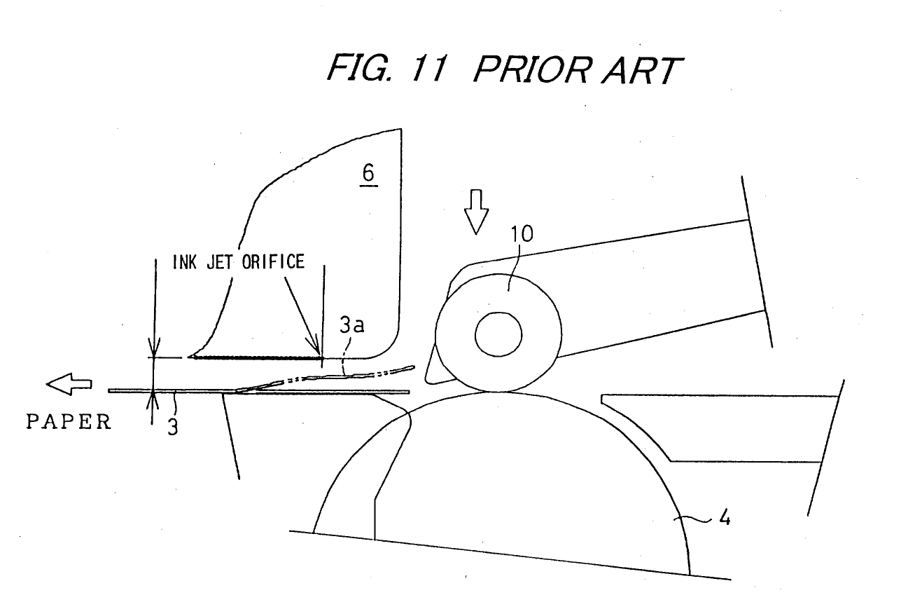

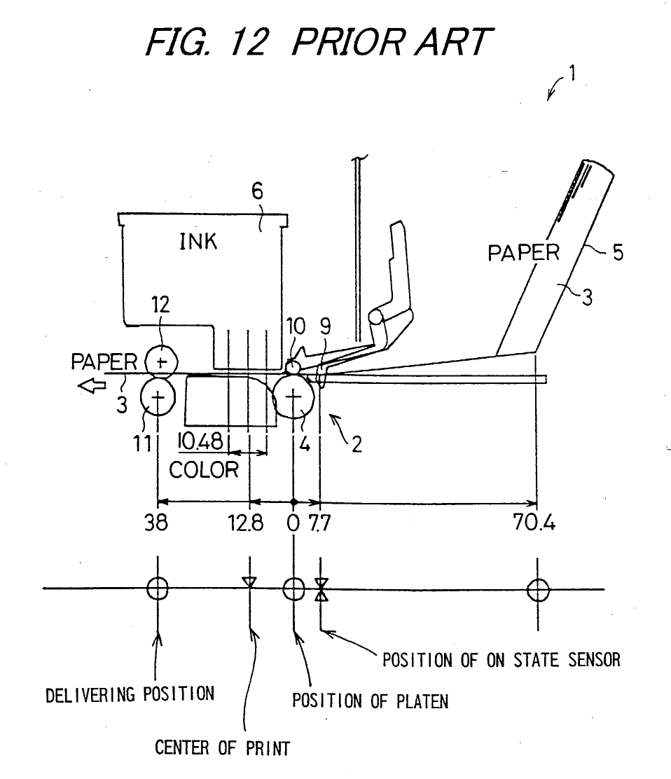

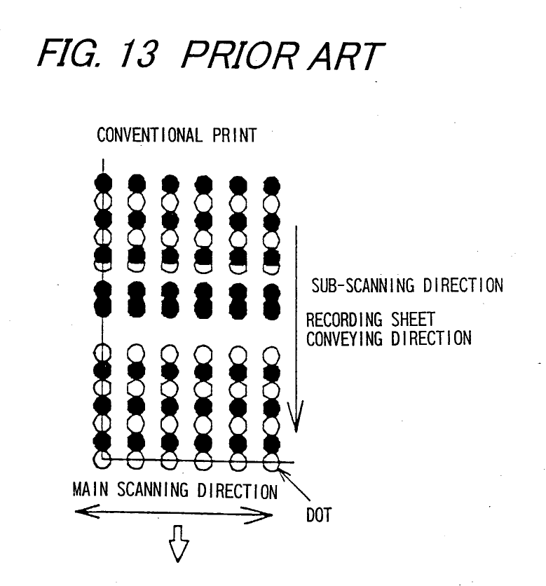

FIG. 7 is a flow chart of a series of operation sequences executed at the control unit 34. Wherein, Si (i=1, 2, 3) denotes a step. FIG. 8 is a schematic plan view of print dot made by the ink jet printer 20 in accordance with one embodiment of the invention. At step S1, operation sequence is started, and at step S2 a standby state is come into, and then at step 3 whether a print command is issued from the personal computer 24 is judged. When print command exists, the operation sequence proceeds to step S4, and the above mentioned operation of feeding the recording sheet 25 is performed, and the leading end of the recording sheet 25 is conveyed and stopped to a print starting position by the upstream side conveying mechanism 21. With this operation, a nozzle jet surface of the ink cartridge 27 arranged on a home position P1 is cleaned using a wiper rubber (not shown) and ink is jetted from the nozzle. Subsequently, at step S5 the maintenance motor 35 is driven and the ink cartridge 27 is maintained by a maintenance unit. Subsequently, the operation sequence proceeds to step S6 and the ink cartridge 27 is moved from the initial home position P1 to a print standby position P2 by the career motor 28.

Subsequently, at step S7 the ink cartridge 27 spits out ink on the basis of print data and various printing data which are previously set printing data, the printing data, for instance, being a desired recording objective among a plain paper, a post card and a photo or the like and a desired standard size among standard sizes of A4, A5 or the like of the recording sheet 25 along with moving from right to left in the main scanning direction from the print start position for the recording sheet 25. After print on the first line is terminated, at step S8 the ink cartridge 27 is moved from left to right in the main scanning direction and is returned to the print standby position P2. Subsequently, at step S9 the recording sheet 25 is accurately conveyed by one line in the downstream side of the conveying direction, namely, in the sub-scanning direction and subsequently print on the second line is performed similarly as described above. In this way, print is performed on each line in the main scanning direction on the basis of print data and printing data along with sequentially conveying the recording sheet 25 by one line to the discharge roller 45 by the platen roller 40 of the upstream side conveying mechanism 21. When the recording sheet 25 is conveyed to the discharge roller 45 of the downstream side conveying mechanism 37, print is performed on each line in the main scanning direction on the basis of print data and printing data along with sequentially conveying the recording sheet 25 by one line in the sub-scanning direction in cooperation with the upstream side conveying mechanism 21 and the downstream side conveying mechanism 37.

Subsequently, at step S10 when the tail end of the recording sheet 25 passes through the recording sheet detecting sensor 31 and the control unit 34 detects that the recording sheet detecting sensor 31 is turned off, print corresponding to one line is terminated. Subsequently, after operation sequence proceeds to step S11, and after the tail end of the recording sheet 25 is apart from the platen roller 40 and the recording sheet pressure roller 41 in a state where the recording sheet 25 is in pressure-contact therewith toward the downstream side of the conveying path H, the recording sheet 25 is conveyed by one line only by the downstream side conveying mechanism 37 and then print is performed along the main scanning direction. Subsequently, the recording sheet 25 is conveyed until the last line in the sub-scanning direction only by the downstream side conveying mechanism 37 and then print is performed on the basis of print data and printing data. Subsequently, at step S12 a discharge operation of the printed recording sheet 25 is performed by the downstream side conveying mechanism 37 and the recording sheet 25 is discharged onto the recording sheet discharge tray. Subsequently, at step S13 when it is judged that continuous print is performed, the operation sequence is returned to step S4, whereas when it is judged that the continuous print is not performed, the operation sequence is returned to step S1.

According to the ink jet printer 20 described above, when the tail end of the recording sheet 25 passes through the upstream side conveying mechanism 21 or after the tail end of the recording sheet 25 passes through the upstream side conveying mechanism 21, the paper pressure flexible sheet 22 guides the recording sheet 25 under the predetermined pressure-contact condition. Therefore, such a problem of the change of conveying amount of the recording sheet 25 caused by change of conveying speed of the recording sheet 25 as mentioned concerning the conventional technique can be previously solved. Accordingly, as shown in FIG. 8, print of a black circle and a white circle of print dot is recorded on a normal position without adverse effect on print caused by conveying unevenness of the recording sheet 25 occurring at the moment that the recording sheet 25 is apart from the platen roller 40 and the recording pressing roller 41. Consequently, cross lines in the main scanning direction of the recording sheet 25 or color unevenness in the case of polychromic print can be certainly prevented from occurring. In addition, a relative distance of the recording sheet 25 to the ink jet orifice 27a of the ink cartridge 27 can be always stabilized and therefore variation of an impact point of ink can be suppressed and color unevenness in the case of polychromic print can be prevented from occurring. In addition, since the paper pressure flexible sheet 22 is provided in the holder 42 of the upstream side conveying mechanism 21, quality of print can be improved at the time of performing the print on the tail end of the recording sheet 25 and its configuration can be simplified.

As other embodiment in accordance with the invention, the guiding means is not always restricted to the sheet of synthetic resin, and a metal having appropriate elastic force (for instance, a flat spring or a tension spring) may be applied to the guiding means. In addition, as the guide means, mechanism, having a rotating shaft, in which a rotational acting part is provided on one side and a guiding portion being in contact with (or allowable to be not in contact with), for instance, the platen roller is provided on another side, and the tail end of the recording sheet is prevented from rising by the guiding portion, may be applied. In the embodiment, the three paper pressure flexible sheets 22 are provided in holders 42, respectively, but the embodiment is not restricted to these three paper pressure flexible sheets 22, and at least two, i.e., right and left, paper pressure flexible sheets 22 may be provided for each holder 42, whereby it is possible to use members efficiently. There is a case where various partial changes in the embodiment are performed within the extent of no deviation from the scope of the claims.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An image forming apparatus comprising:
recording means for recording a desired image on a recording medium;
recording medium conveying means capable of conveying the recording medium, including upstream side conveying means and arranged on an upstream side of the recording means along a conveying path and downstream conveying means arranged on a downstream side of the recording means along the conveying path; and
guiding means for guiding the recording medium under a predetermined pressure-contact condition when a tail end of the recording medium passes through the upstream side conveying means or after the tail end of the recording medium passes through the upstream side conveying means.

2. The image forming apparatus of claim 1, wherein the guiding means is provided in the upstream side conveying means.

3. The image forming apparatus of claim 1, wherein the upstream side conveying means comprises:
a pair of rotating rollers capable of sandwiching the recording medium between the rollers and being rotatable; and
a roller holder supporting one rotating roller which is elastically energized against another rotating roller,
wherein the guiding means is provided in the roller holder.

4. The image forming apparatus of claim 1, wherein the guiding means is formed of a sheet of synthetic resin.

5. The image forming apparatus of claim 1, wherein the guiding means is formed of a metal.

6. The image forming apparatus of claim 1, wherein the guiding means guides the tail end of the recording medium between the upstream side conveying means and the recording means under the predetermined pressure-contact condition.
